(19) United States
(12) Patent Application Publication
(10) Pub. No.: US 2010/0043292 A1
(43) Pub. Date: Feb. 25, 2010

(54) WINDOW AND COMBINED DEFENCE SHUTTER AND BLIND

(76) Inventor: Brian Malcolm Wilkins, Retford (GB)

Correspondence Address: Kenneth Watov;Watov & Kipnes, P O Box 247, Princeton Junction, NJ, 08550, US

(21) Appl. No.: 12/312,558

(22) PCT Filed: Nov. 16, 2007
(86) PCT No.: PCT/GB2007/004379

§ 371 Date: May 15, 2009

(30) Foreign Application Priority Data
Nov. 16, 2006 (GB) 0622882.9

(51) Int. Cl. E06B 7/08; E06B 9/02; E06B 5/12; F41H 5/00

(52) U.S. Cl. 49/64; 89/36.01

(57) ABSTRACT

A combined defence shutter and blind is located in a window opening inwardly of the window. The shutter comprises a shutter frame secured in the window opening, and a plurality of parallel blades extending across the shutter frame, each said blade having in cross-section a shape which includes a point at each opposed edge of the blade and having a reinforcing axial member extending therethrough and engaged in respective opposing sides of the shutter frame. The blades are linked together and rotatable such that rotation of one blade induces the other blades to rotate simultaneously between a closed position, in which the blades lie substantially parallel to the window so as to form a continuous shutter, and an open position substantially normal to the closed position. The window has anti-shatter material extending over the entire inner surface thereof, whereby, in the event of an explosion outside the window causing a pressure wave to blow the window inwardly of the building, the window and anti-shatter material contacting at least a portion of a pointed edge of at least one of the blades when in the open position to rotate to the closed position, thereby preventing ingress of the pressure wave and glass from the window into the building.

### FIELD OF THE INVENTION

This invention relates to a window located in a window opening in a building and having a combined defence shutter and blind suitable for resisting the effects of an explosion outside the building. The invention also provides ballistics-resisting defence shutters.

### BACKGROUND TO THE INVENTION

The use of security shutters in windows is well known in preventing unauthorised access through a window, i.e. preventing burglary. Equally, the use of various types of blinds for use with windows, in which the strips are rotatable so as to overlap to form a continuous closed surface or to extend normally to the window to allow light and air through is also well known.

The combination of these two elements is also already known from my published application WO02/06620.

However it has since been found that the combination of the security shutter and blind with a modified window can be used as a defence screen against a blast occurring outside the building.

The need for such protection has arisen over recent years with the increase in both terrorist attacks, and crime. In many of the terrorist attacks involving bomb blasts a high percentage of the deaths suffered have been caused by the absence of any protection from the flying debris of the blast and glass from broken windows.

Additionally, there is a need in some circumstances to provide protection against ballistic attack, for example from drive-by shootings, or stray bullets arising from combat activity.

### SUMMARY OF THE INVENTION

According to the invention, there is provided a window located in a window opening in a building and having a combined defence shutter and blind located in the window opening inwardly of the window, wherein the shutter comprises a shutter frame secured in the window opening, and a plurality of parallel blades extending across the shutter frame, each said blade having in cross-section a shape which includes a point at each opposed edge of the blade and having a reinforcing axial member extending therethrough and engaged in respective opposing sides of the shutter frame, the blades being linked together and rotatable such that rotation of one blade induces the other blades to rotate simultaneously between a closed position, in which the blades lie substantially parallel to the window so as to form a continuous shutter, and an open position substantially normal to the closed position, and wherein the window has anti-shatter material extending over the entire inner surface thereof, whereby, in the event of an explosion outside the window causing a pressure wave to blow the window inwardly of the building, the window and anti-shatter material contacting at least a portion of a pointed edge of at least one of the blades when in the open position to rotate to the closed position, thereby preventing ingress of the pressure wave and glass from the window into the building.

The sliding of the blades, or alternatively, opening of the mounting frame, will be necessary for reasons of safety, to permit escape from the building through the window in an event of an emergency, any maintenance, and to permit cleaning of the inner surface of the window, for example.

Although reference is made throughout to “windows”, it will be understood that the invention is applicable to glazed doors and the like.

Preferably, the blades are formed from a strong lightweight material such as aluminium or the like. Alternatively, the blades may be formed of a plastics material, which may be further reinforced by the incorporation of a strengthening material such as Kevlar®. These materials may be suitably formed into shape by extrusion, internal spacing within the blade may be left hollow to provide the blade with suitable flexibility.

A blast occurring outside the building triggers the closure of the blind. The force of the blast causing the glass of the window to break, or flying debris hitting the glass causing it to shatter, distorts both the window and in turn the anti-shatter material on the inside of the window. The window and anti-shatter material contact at least a portion of a pointed edge of at least one of the blades when in the open position to rotate it to the closed position, thereby preventing ingress of the pressure wave and glass from the window into the building.

The spindles may be joined together by other cords or similar flexible members, coupled at predetermined intervals to the spindles so as to regulate their spacing one from the another and to permit the spindles, when released by the spindle locking means, to be slid along the track and collected together at one end thereof, giving free access to the window. A pulley may achieve the sliding of the blades in each direction. An alternative arrangement provides a separate cord loop connected only to the end of the spindle, with means to pull the loop in the two directions, either to slide the blades to their spaced positions across the window or gather them.

The inside of the window surface is covered with an anti-shatter material; this may be perforated steel, or an anti-shatter film. Alternatively, a polycarbonate or similar sheet may be used. In the event of a blast the area of the window to shatter first is the area in which maximum distortion occurs, this then triggers the chain of events that initiates the closing of the blast defence screen. The essential role of the anti-shatter material is to keep the window in its shattered state together long enough to permit the blades to completely close and form the continuous defence screen before any pressure wave or blast material may enter the building.

The blades comprise an aerodynamic shape with an extruded hollow pointed oval cross-section that plays a key role in determining the speed at which the blades operate in response to the blast. The narrowest part of the oval blade is the initial part that triggers the displacement reaction.

The metal members passing through the blades are suitably steel rods. Further reinforcement may be gained by the use of a reinforced metal bar, of suitable dimensions, which can be secured adjacent to the blades across the window opening by lockable means, thereby temporarily preventing rotation of the blades. This reinforced metal bar would be of particular use if there were some prior warning of a blast or ballistic attack, for example the sound of a blast/gun shot some distance from the building.

The blind will close reliably and rapidly in the event of an explosion or other attack on the window, even if all the blades are exactly at 90 degrees to the window glass surface initially. If the blades are not at exactly 90 degrees, the rotation of the blades will occur even more rapidly. At the 90 degree position, the tips of the blades may be in contact with the glass or may be spaced therefrom; the efficiency of closure of the blind in response to an explosion is unaffected.

Blast experiments conducted have shown that the defence shutter can withstand a blast produced by the detonation of 500 kg of TNT equivalent at a distance of 28.5 metres from the shutter.

Each blade may be formed with hollow spaces therein, and the hollow spaces may be filled with a ballistics retarding material. Alternatively, each blade is formed from a moulded ballistics retarding composite resin and fibre material.

Each blade may be provided alongside each opposed edge thereof with a hook formation that engages with the hook formation on the next adjacent blade to hold the blades together in the closed position thereof, the hooks disengaging when the blades rotate back towards the open position thereof.

All the blinds in accordance with different aspects of the invention provide security from attempted break-ins to the building, while giving the appearance of conventional vertical blinds, as well as protecting the occupants from the effects of explosions outside the building.

### BRIEF DESCRIPTION OF THE DRAWINGS

In the drawings, which illustrate exemplary embodiments of the invention:

FIGS. 1 to 4 are horizontal sections through a window and security shutter according to a first aspect of the invention, showing successively the effect of an explosion outside the window;

FIG. 5 is a perspective view of a top portion of one of the blades in the shutter of FIGS. 1 to 4, showing in enlarged detail the linkage between the blades;

FIG. 6 is a perspective view of portions of two blades in a shutter according to another aspect of the invention;

FIG. 7 is a perspective view of a portion of a blade according to an alternative embodiment of the invention;

FIG. 8 is a perspective view of a portion of another alternative blade;

FIG. 9 is a horizontal section through a pair of blades according to yet another embodiment of the invention; and

FIG. 10 is a perspective view of a top portion of one of the blades in the shutter according to another embodiment, showing the retention of the reinforcing members in the shutter frame.

### DETAILED DESCRIPTION OF THE ILLUSTRATED EMBODIMENTS

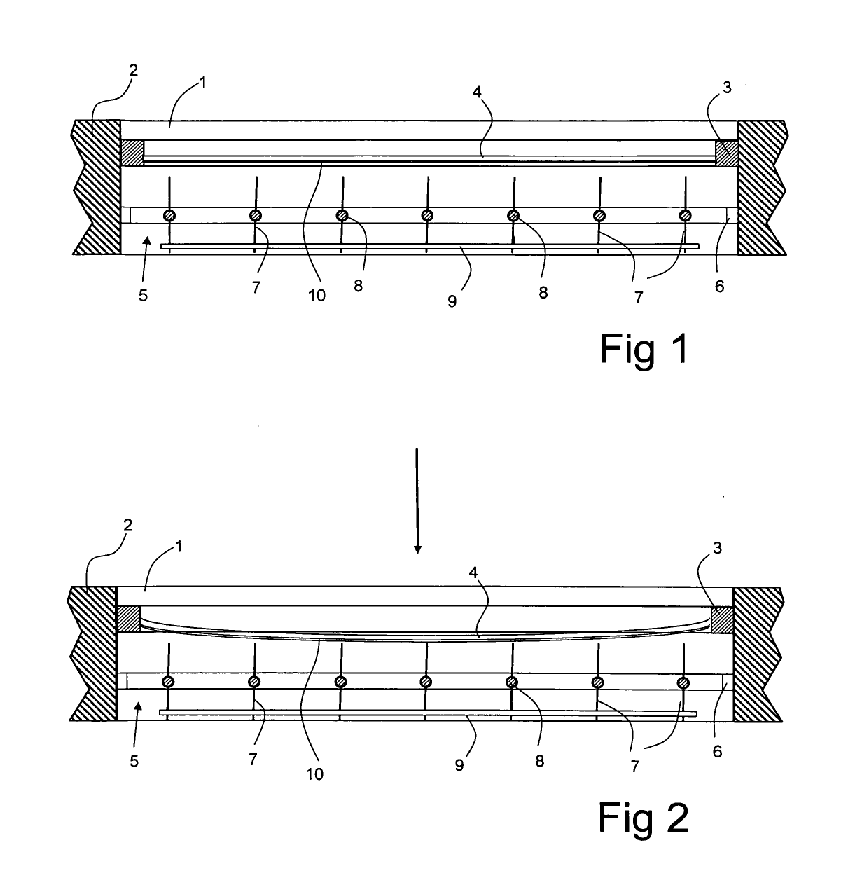

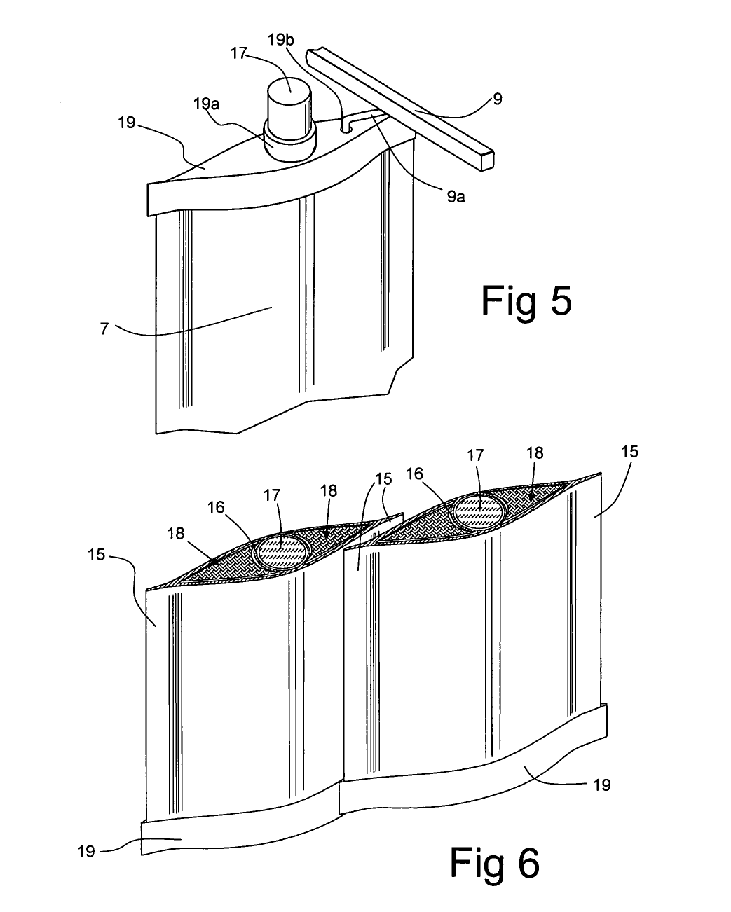

Referring first to FIGS. 1 to 4, a window opening 1 in a building 2 has a window frame 3 mounted therein in conventional manner, the window frame mounting a glass sheet 4 (alternatively, a sealed double-glazing unit could be used). A combined defence shutter and window blind 5 (hereinafter referred to as a blind) is also mounted within the window opening 1, inside the building relative to the window 3, 4. The blind 5 consists of a frame 6 which may be mounted in the window opening 1 so as to hinge open, for example for access to the window for cleaning and maintenance or for emergency egress from the building. A plurality of parallel vertical blades 7 are mounted within the frame. Each blade 7 has a steel reinforcing rod 8 passing therethrough, the rods 8 being secured in the frame in such a manner as to permit rotation of the blades around the longitudinal axis of the rods. The blades 7 are shaped so as to disguise the presence of the rods 8 and to give the appearance of conventional vertical blinds. In cross-section, the blades narrow down to substantially a point on each side of the rod, providing thin edges along the blades. The blades may be linked together by cords or chains so that, when one blade is rotated, all the other blades are caused to rotate simultaneously, but are preferably linked together by a linking bar 9, hereinafter described in more detail with reference to FIG. 5. In this way, the blades may be rotated between a fully open position, in which the blades extend substantially normally to the window glass 4, as illustrated in FIG. 1, and a closed position, in which the blades extend substantially parallel to the window glass 4, overlapping to form a continuous shutter. Cord and pulley means are provided in conventional manner to permit rotation of the blades selectively between their open and closed positions, for example to control ingress of sunlight to the building or for privacy.

The window glass 4 is provided with a layer 10 of an anti-shatter material extending over the entire inner surface thereof. The anti-shatter material may comprise a flexible plastics film, for example of poly(ethylene terephthalate), adhered thereto, or a sheet of transparent polycarbonate plastics material mounted against it, or a perforated sheet of a metal such as steel, in which the perforations comprise a sufficiently large proportion of the surface to permit occupants of the building to see through the window, but are sufficiently small to prevent sherds of broken glass to pass through them in the event of an explosion outside the building. The anti-shatter material distorts in the event of an impact on the glass 4, absorbing some energy, but serves to hold the window glass together in the event of the window breaking. It has been found that the combination of the anti-shatter film and the point edge on the blades ensures that, in the event of an explosion outside the building, the blind is automatically closed quickly enough to prevent broken glass entering the building and to resist the effects of the explosive pressure wave, thereby protecting any occupants of the building from any injury.

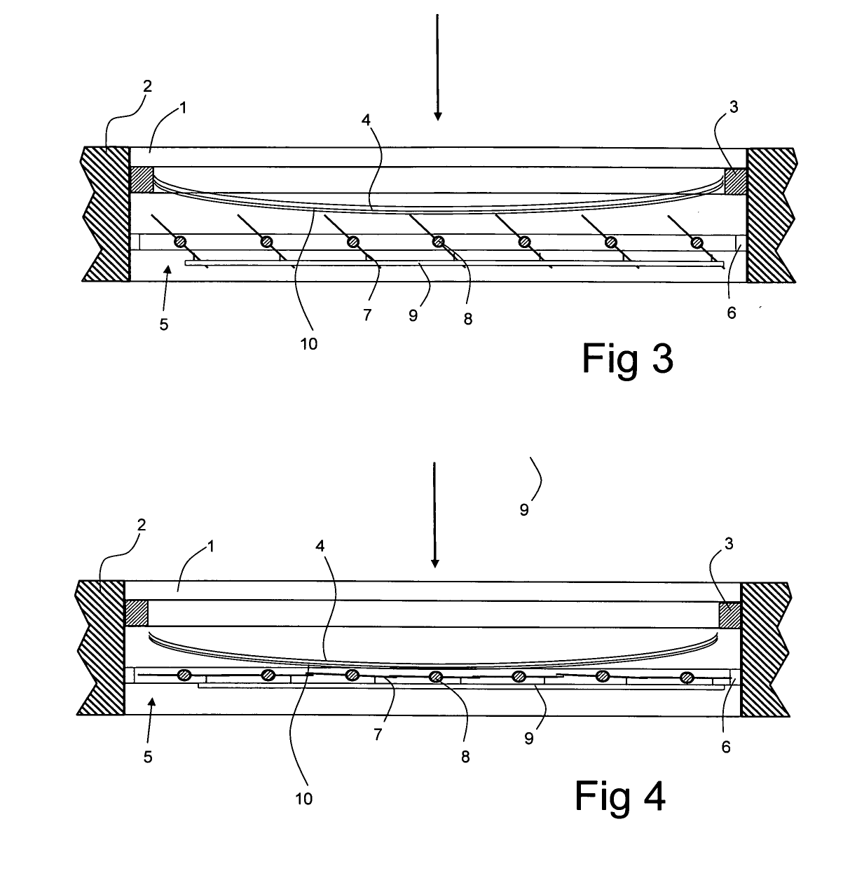

FIG. 1 illustrates the position in normal use of the blind, while FIGS. 2 to 4 show the result of an explosion outside the building. In FIG. 2, the pressure wave from the explosion has caused inward distortion of the window glass 4 to the point where the anti-shatter material 10 contacts the blades 7. Since the maximum distortion will be at the centre of the window, it is desirable to ensure that one of the blades is at the centre line of the window, i.e. that the blind has an odd number of blades. Contact with the blade causes the blade to be deflected to one side—the point edge ensures that this happens, rather than the blades being jammed in the open position. Because the blades 7 are linked together, all the blades start to rotate in the same direction. Continued distortion of the glass 4 continues the rotation of the blades, as illustrated in FIG. 3.

The glass 4 will break as a result of continued distortion by the pressure wave and start to move into the building, the anti-shatter material holding the broken glass together at this point. The inward movement of the glass closes the blind completely, forming a continuous shutter or barrier against which the glass and anti-shatter material impinge. Distortion of the blades, the rods, and the supporting frame all serve to absorb energy, ensuring that the integrity of the shutter is not compromised. The pressure wave therefore does not enter the building, and the glass is held by the shutter, as illustrated in FIG. 4. In practice, a reverse pressure flow will follow the initial expansive pressure wave, and this has been found to pull the broken glass out of the building, to be deposited on to the ground beneath the window.

FIG. 5 shows the top part of a blade with an end cap 19 fitted thereto, the end cap having a central boss 19a through which the reinforcing rod 17 passes to engage in the frame of the blind. The end cap is also provided with an offset hole 19b into which is inserted the downturned end of a stepped metal arm 9a extending from the underside of the linking bar 9, which extends across the tops of the blades. Rotation of one of the blades pulls on its arm 9a, which serves as a crank, displacing the bar 9 laterally and so transmitting the same movement to each of the other blade end caps 19 and so to the associated blade 7.

FIG. 6 shows a modification of the blind to provide protection from ballistics. The blades are formed as hollow plastics or aluminium extrusions having a flattened oval shape with fins 15 at each side thereof and a central tubular formation 16 into which the reinforcing rod 17 is inserted. In the case of an aluminium extrusion, the central formation 16 would conveniently be formed as a discontinuous circle in cross-section, to permit the use of a single extrusion mandrel. On either side of the central tubular formation 16 hollow voids 18 are formed, into which woven fibre ballistics resisting material, for example that sold under the trade mark Kevlar®, is inserted. End caps 19 close the ends of the blades and helps to retain the inserted material in place. The blades are mounted in the shutter frame with a closer relative spacing than in the embodiment shown in FIGS. 1 to 4, so that when the blind is closed, the blades overlap sufficiently to ensure that a layer of the ballistics-resisting material is present across the entire width of the blind to impede the passage of lower-powered bullets, for example from handguns or arising from incidental fire, as opposed to direct sniper fire with high-velocity weapons. For greater protection, the woven fibre material may be replaced by moulded boards of resin-bonded fibres, for example as used in body armour.

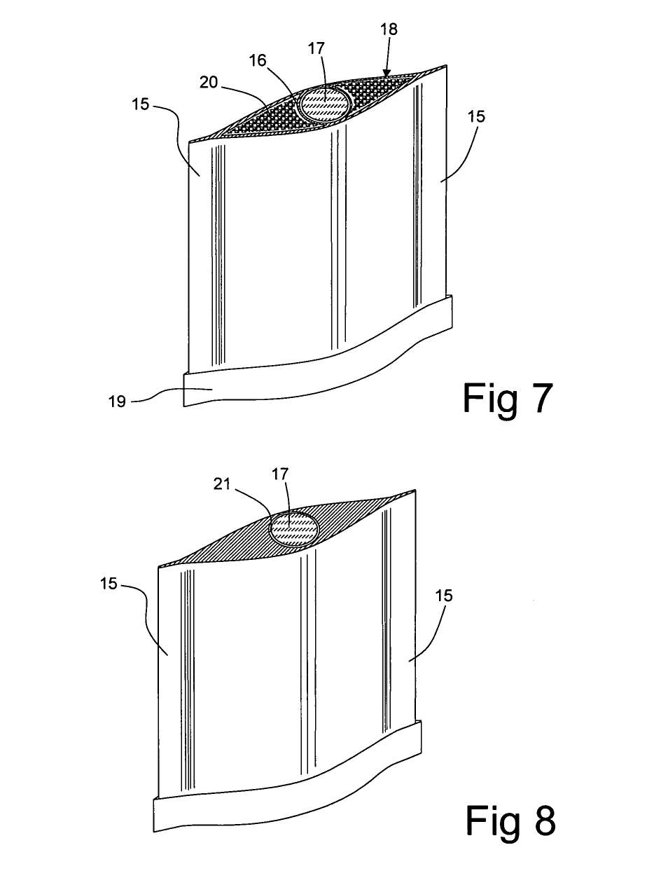

Greater protection may also be afforded by the use of small ceramic spheres as a filler 20, as illustrated in FIG. 7. The spheres will typically have a diameter of less than 1 mm, and a bullet striking the blind will lose a substantial amount of its kinetic energy by absorption into the ceramic material.

FIG. 8 shows another embodiment, in which the entire blade is moulded from resin-bonded ballistics-resisting fibres to achieve the desired shape and with a tubular bore 21 therethrough to receive the reinforcing rod 17.

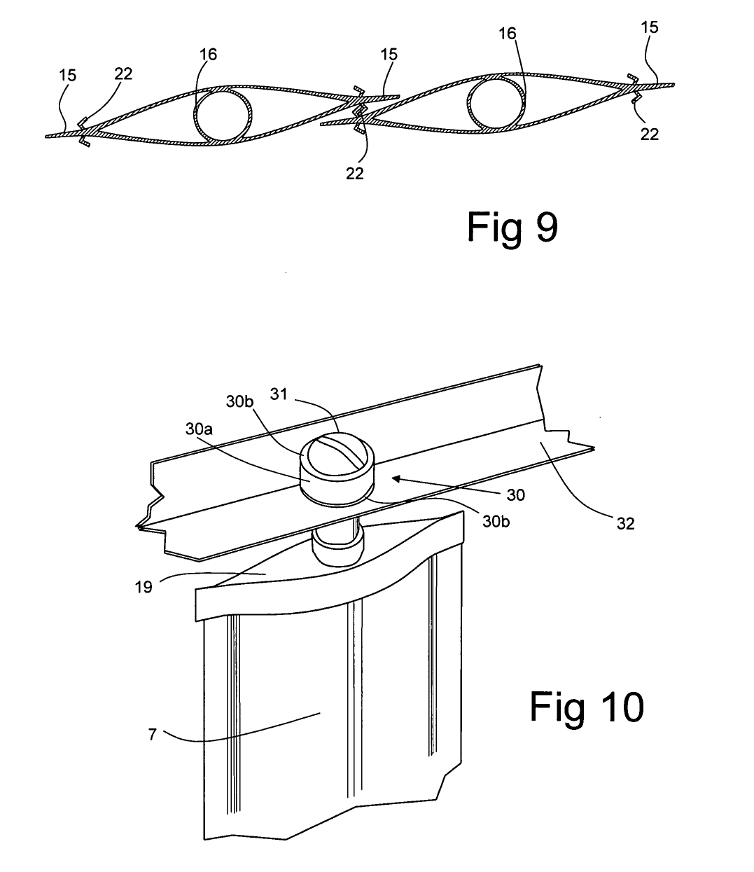

Yet another embodiment is illustrated in FIG. 9. The blades are extruded as described with reference to FIG. 6, but are additionally provided with hook formations 22 along the opposed edges, on either side of the longitudinal fin 15, the hook formations being angled outwardly so as to be engageable with another such formation on the next adjacent blade when the blades are in their closed positions and distortion of the blind takes place. In this way, separation of the blades is resisted, and the continuous shutter surface remains effective in the event of an explosion. While this might be important in protecting from the effects of an explosion, it might be especially important to protect from ballistics attack, by guaranteeing that there can be no separation of the blades through which a bullet might pass. The hook formations automatically disengage from each other if the blind is not distorted.

To protect the edges of the blind from accidental ingress of a bullet into the room, the frame may be provided with extensions covering any gaps; these need only be effective for line-of-sight, as any likely attack will not be at point-blank range.

It will be appreciated that automatic closure of the blind does not occur in the case of ballistic attack, and it will be necessary for the user to close the blind at first sign of any danger of attack, preferably reinforcing the blind by a support bar extending horizontally across the rear face thereof when closed.

While the various embodiments of the invention have been illustrated and described with reference to the “gated” version, in which the frame in which the blades are mounted is hinged to a fixed frame in the window opening, other configurations are possible, including sliding frames which interlock in the closed position, but which can be slid aside for access to the opening, and a folding or “concertina” version, in which frames fold one against another to provide access to the opening. Also, one embodiment involves mounting the blades to be slidable in the frames, as disclosed in my earlier published application WO02/06620. It will be appreciated that, because the invention depends upon the blades being in the correct positions across the face of the window for the automatic closing to be effective, this embodiment can provide no automatic protection when the blades have been slid aside.

Referring now to FIG. 10, while in some embodiments it will be sufficient for the reinforcing rods to extend through the frame by a distance such that, even with the maximum distortion likely to be experienced, the rods will not be separated from the frame, it will generally be preferred to provide some form of retention in the frame by way of an enlarged head to the rod. For additional protection, it has been found that the provision of a resilient washer 30 between the head 31 and the frame 32 is beneficial. The washer or bush is in the form of a cylinder of hard rubber 30a with a bore therethrough, and with a thin steel washer 30b bonded to each end thereof. The rubber is suitably of 68 Shore A hardness, comparable with the hardness of the rubber in a motor vehicle tyre—the material may be the same as used in motor vehicle tyres. It has been found that the washer or bush absorbs some of the energy dissipated in the reinforcing rods in the event of an explosion or physical attack on the shutter, reducing the distortion of the frame, and thereby enhancing security.

1. A window located in a window opening in a building and having a combined defence shutter and blind located in the window opening inwardly of the window, wherein the shutter comprises a shutter frame secured in the window opening, and a plurality of parallel blades extending across the shutter frame, each said blade having in cross-section a shape which includes a point at each opposed edge of the blade and having a reinforcing axial member extending therethrough and engaged in respective opposing sides of the shutter frame, the blades being linked together and rotatable such that rotation of one blade induces the other blades to rotate simultaneously between a closed position, in which the blades lie substantially parallel to the window so as to form a continuous shutter, and an open position substantially normal to the closed position, and wherein the window has anti-shatter material extending over the entire inner surface thereof, whereby, in the event of an explosion outside the window causing a pressure wave to blow the window inwardly of the building, the window and anti-shatter material contacting at least a portion of a pointed edge of at least one of the blades when in the open position to rotate to the closed position, thereby preventing ingress of the pressure wave and glass from the window into the building.

2. A window according to claim 1, wherein said shutter frame is hingedly secured by one edge to said window opening and configured with releasable locking on an opposing edge for securing said frame within said window opening.

3. A window according to claim 1, wherein opposing sides of said shutter frame configured with respective tracks within which said spindles are engaged; further comprising spindle locking means operable to constrain the spindles from lateral movement along the tracks whilst still permitting rotation thereof, the spindle locking means being releasable to allow lateral movement of the spindles.

4. A window according to claim 1, wherein each said blade has a hollow, pointed oval, cross-sectional shape.

5. A window according to claim 1, preceding claim, wherein the blades are made of aluminium.

6. A window according to claim 1, wherein each blade comprises a plastics extrusion.

7. A window according to claim 1, wherein the reinforcing members comprise steel rods or bars.

8. A window according to claim 1, wherein the anti-shatter material is a polycarbonate sheet.

9. A window according to claim 1, wherein the anti-shatter material is a perforated steel sheet.

10. A window according to claim 1, wherein the anti-shatter material is a flexible plastics film.

11. A window according to claim 1, wherein each blade is provided alongside each pointed edge thereof with a hook formation that engages with the hook formation on the next adjacent blade to hold the blades together in the closed position thereof, the hooks disengaging when the blades rotate back towards the open position thereof.

12. A window according to claim 1, wherein each blade is formed with at least one hollow cavity therein, and the or each cavity is filled with a ballistics retarding material.

13. A window according to claim 12, wherein the ballistics retarding material comprises a woven fibre material.

14. A window according to claim 12, wherein the ballistics retarding material comprises a composite resin and fibre material.

15. A window according to claim 12, wherein the ballistics retarding material comprises a particulate ceramic material.

16. A window according to claim 15, wherein the ceramic material is in the form of ceramic spheres.

17. A window according to claim 16, wherein the spheres have a diameter of less than 1 mm.

18. A window according to claim 1, wherein each end of each of the reinforcing members passes through an aperture in the frame and is retained in place by an enlarged diameter portion, a resiliently compressible washer being provided between the enlarged diameter portion and the frame.

19. A window according to claim 18, wherein the resiliently compressible washer comprises a hollow cylinder of hard rubber bonded between two steel washers.
